(19) United States
(12) Patent Application Publication
(10) Pub. No.: US 2021/0053150 A1
(43) Pub. Date: Feb. 25, 2021

(54) LASER PROCESSING DEVICE AND LASER PROCESSING METHOD

(71) Applicant: TOKYO ELECTRON LIMITED, Tokyo (JP)

(72) Inventors: Hirotoshi MORI, Koshi-shi (JP); Yoshihiro KAWAGUCHI, Koshi-shi (JP); Hayato TANOUE, Koshi-shi (JP); Kazuya HISANO, Koshi-shi (JP)

(73) Assignee: Tokyo Electron Limited, Tokyo (JP)

(21) Appl. No.: 16/977,495

(22) PCT Filed: Mar. 18, 2019
(86) PCT No.: PCT/JP2019/011231

§ 371 Date: Sep. 2, 2020

(30) Foreign Application Priority Data
Mar. 30, 2018 (JP) 2018-069540

(51) Int. Cl. B23K 26/08; B23K 26/364; B23K 26/53

(52) U.S. Cl. CPC B23K 26/0823; B23K 26/53; B23K 26/364

(57) ABSTRACT

A laser processing device configured to form an irradiation point of a laser beam for processing a substrate on a main surface of the substrate held on a substrate holder and configured to form processing traces by moving the radiation point on dividing target lines of the substrate includes a processing unit configured to repeat, while switching the dividing target lines, moving the substrate holder in a first axis direction to move the irradiation point on the dividing target lines and configured to rotate the substrate holder around a third axis during the moving of the substrate holder to change a direction of the substrate held on the substrate holder by 180°.

### TECHNICAL FIELD

The various aspects and embodiments described herein pertain generally to a laser processing device and a laser processing method.

### BACKGROUND

A main surface of a substrate, such as a semiconductor wafer, is partitioned into a plurality of streets formed in a lattice shape, and in each of the divided regions, elements, circuits, terminals, and the like are formed in advance. Chips can be obtained by dividing the substrate along the plurality of streets formed in the lattice shape. The substrate may be divided by using, for example, a laser processing device.

A laser processing device disclosed in Patent Document 1 forms, on a main surface of a substrate held by a substrate holder, an irradiation point of a laser beam for processing the substrate and forms processing traces by moving the irradiation point in an X-axis direction and a Y-axis direction orthogonal to each other. As a result, the processing traces are formed along dividing target lines formed in a lattice shape.

### PRIOR ART DOCUMENT

Patent Document 1: Japanese Patent Laid-open Publication No. 2011-091293

### DISCLOSURE OF THE INVENTION

### Problems to be Solved by the Invention

An aspect of the present disclosure provides a technology capable of reducing an installation space for a laser processing device.

### Means for Solving the Problems

In one exemplary embodiment, a laser processing device configured to respectively form processing traces along multiple dividing target lines of a substrate includes: a substrate holder configured to hold the substrate; a processing head unit configured to form an irradiation point of a laser beam for processing the substrate on a main surface of the substrate held on the substrate holder; a substrate moving unit configured to move the substrate holder in a first axis direction and a second axis direction, which are orthogonal to each other and parallel to the main surface of the substrate, and configured to rotate the substrate holder around a third axis orthogonal to the main surface of the substrate; and a controller configured to control the substrate moving unit. Further, the controller includes a processing unit configured to repeat, while switching the multiple dividing target lines, moving the substrate holder in the first axis direction to move the irradiation point on the multiple dividing target lines and configured to rotate the substrate holder around the third axis during the moving of the substrate holder to change a direction of the substrate held on the substrate holder by 180°.

### Effect of the Invention

According to the present exemplary embodiments, it is possible to reduce the installation space for the laser processing device.

### BRIEF DESCRIPTION OF THE DRAWINGS

FIG. 1 is a perspective view illustrating a substrate which has not been processed by a substrate processing system according to a first exemplary embodiment.

FIG. 2 is a plan view illustrating the substrate processing system according to the first exemplary embodiment.

FIG. 3 is a flowchart showing a substrate processing method according to the first exemplary embodiment.

FIG. 4A and FIG. 4B show plan views illustrating a laser processing unit according to the first exemplary embodiment.

FIG. 5 is a front view illustrating the laser processing unit according to the first exemplary embodiment.

FIG. 6 is a side view illustrating a processing head unit and a substrate holder according to the first exemplary embodiment.

FIG. 7 illustrates components of a controller as functional blocks according to the first exemplary embodiment.

FIG. 8 is a plan view illustrating an example of movement of the substrate in an X-axis direction and a Y-axis direction by a processing unit according to the first exemplary embodiment.

FIG. 9 is a plan view illustrating an example of rotation of the substrate around a Z-axis by the processing unit subsequent to FIG. 8.

FIG. 10 is a plan view illustrating an example of the movement of the substrate by the processing unit in the X-axis direction and the Y-axis direction subsequent to FIG. 9.

FIG. 11 is a plan view illustrating an example of the movement of the substrate by an inspection processing unit in the X-axis direction and the Y-axis direction according to the first exemplary embodiment.

FIG. 12 is a plan view illustrating an example of rotation of the substrate around the Z-axis by the inspection processing unit subsequent to FIG. 11.

FIG. 13 is a plan view illustrating an example of the movement of the substrate by the inspection processing unit in the X-axis direction and the Y-axis direction subsequent to FIG. 12.

FIG. 14 is a plan view illustrating a laser processing unit according to a second exemplary embodiment and illustrating a status at a time t2 shown in FIG. 17.

FIG. 15 is a plan view illustrating the laser processing unit according to the second exemplary embodiment and illustrating a status at a time t1 shown in FIG. 17.

FIG. 16 is a plan view illustrating a moving area of each of a plurality of substrates held by a plurality of substrate holders, respectively, according to the second exemplary embodiment.

FIG. 17 is a time chart provided to explain a processing of a controller according to the second exemplary embodiment.

FIG. 18 is a plan view illustrating a positional relationship between the moving area of the substrate held by the substrate holder on the left side during a processing and the moving area of the substrate held by the substrate holder on the right side during an inspection according to the second exemplary embodiment.

FIG. 19 is a plan view illustrating the positional relationship between the moving area of the substrate held on the substrate holder on the left side during the inspection and the moving area of the substrate held on the substrate holder on the right side during the processing according to the second exemplary embodiment.

FIG. 20 is a plan view illustrating the moving area of each of a plurality of substrates held by a plurality of substrate holders, respectively, according to a comparative example.

FIG. 21A and FIG. 21B show plan views illustrating a modification example of the movement of the substrate by the processing unit in the X-axis direction and the Y-axis direction subsequent to FIG. 9.

FIG. 22A and FIG. 22B show plan views illustrating two examples of expansion of the substrate, which is caused by formation of the processing traces, while the processing traces extended in the X-axis direction are formed at an interval along the Y-axis direction.

FIG. 23A and FIG. 23B show plan views illustrating a modification example of the movement of the substrate by the inspection processing unit in the X-axis direction and the Y-axis direction subsequent to FIG. 12.

### DETAILED DESCRIPTION

Hereinafter, exemplary embodiments of the present disclosure will be described with reference to the accompanying drawings. In the drawings, same or corresponding parts will be assigned same or corresponding reference numerals, and redundant description may be omitted. In the following description, the X-axis direction, the Y-axis direction and the Z-axis direction are orthogonal to each other. The X-axis direction and the Y-axis direction are horizontal directions, and the Z-axis direction is a vertical direction. A rotation direction around a vertical axis is also referred to as θ direction. In the present exemplary embodiments, the X axis corresponds to a first axis described in the claims, the Y-axis direction corresponds to a second axis described in the claims, and the Z-axis corresponds to a third axis described in the claims. In the present specification, the term “downward” refers to “downward in the vertical direction”, and the term “upward” refers to “upward in the vertical direction”.

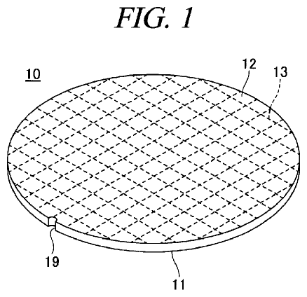

FIG. 1 is a perspective view illustrating a substrate which has not been processed by a substrate processing system according to a first exemplary embodiment. A substrate 10 is, for example, a semiconductor substrate, a sapphire substrate, or the like. A first main surface 11 of the substrate 10 is partitioned into a plurality of streets formed in a lattice shape, and in each of the divided regions, elements, circuits, ports, and the like are formed in advance. Chips can be obtained by dividing the substrate 10 along the plurality of streets formed in the lattice shape. Dividing target lines 13 are set on the streets.

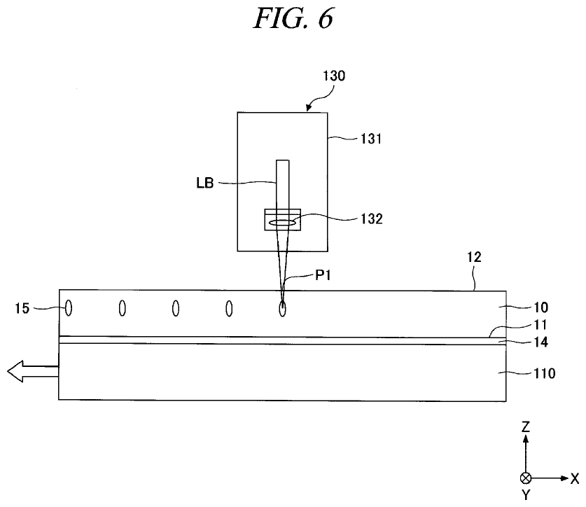

A protective tape 14 (see FIG. 6) is attached to the first main surface 11 of the substrate 10. While a laser processing is performed, the protective tape 14 protects the first main surface 11 of the substrate 10 to protect the devices formed in advance on the first main surface 11. The protective tape 14 entirely covers the first main surface 11 of the substrate 10.

The protective tape 14 is formed of a sheet member and an adhesive coated on the surface of the sheet member. By irradiating the UV light to the adhesive, the adhesive may be cured and the adhesive strength thereof may be decreased. After the decrease in the adhesive strength, the protective tape 14 can be easily peeled off from the substrate 10.

Further, the protective tape 14 may be provided on a ring-shaped frame so as to cover an opening of the frame and bonded to the substrate 10 at the opening of the frame. In this case, the substrate 10 can be transferred while being held on the frame. Thus, the handling property of the substrate 10 can be improved.

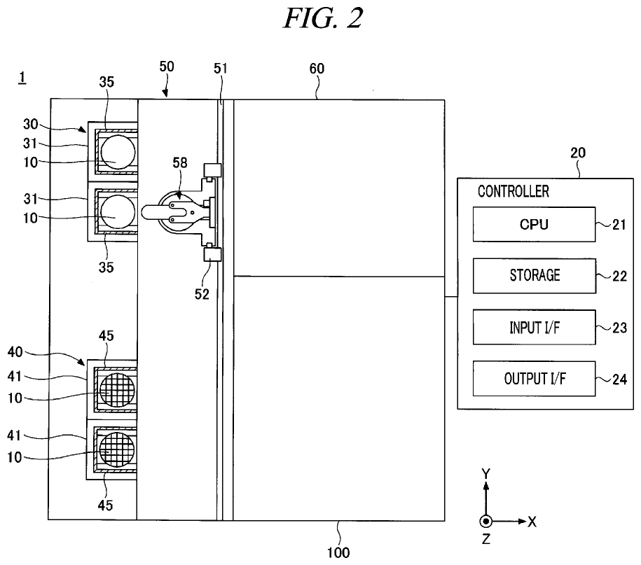

FIG. 2 is a plan view illustrating the substrate processing system according to the first exemplary embodiment. FIG. 2 is a cutaway view of a carry-in cassette 35 and a carry-out cassette 45 and illustrates the inside of the carry-in cassette 35 and the inside of the carry-out cassette 45.

A substrate processing system 1 is a laser processing system configured to perform a laser processing on the substrate 10. The substrate processing system 1 includes a controller 20, a carry-in unit 30, a carry-out unit 40, a transfer path 50, a transfer unit 58 and various processing units. The processing units are not particularly limited and may include, for example, an alignment unit 60 and a laser processing unit 100. Further, in the present exemplary embodiment, the laser processing unit 100 corresponds to a laser processing device described in the claims.

The controller 20 is configured as, for example, a computer and has a central processing unit (CPU) 21, a storage 22 such as a memory, an input interface 23 and an output interface 24 as illustrated in FIG. 2. The controller 20 is configured to perform various controls when the CPU 21 executes a program stored in the storage 22. Also, the controller 20 receives a signal from the outside through the input interface 23 and transmits a signal to the outside through the output interface 24.

A program of the controller 20 is stored in a data storage, and is installed from the data storage. Examples of the data storage may include a hard disk (HD), a flexible disk (FD), a compact disk (CD), a magneto optical disc (MO) or a memory card. Further, the program may be installed by being downloaded from a server through the Internet.

The carry-in cassette 35 is carried into the carry-in unit 30 from the outside. The carry-in unit 30 is equipped with a placing plate 31 on which the carry-in cassette 35 is placed. A plurality of placing plates 31 is provided in a row along the Y-axis direction. The number of placing plates 31 is not limited to the illustrated embodiment. The carry-in cassette 35 accommodates a plurality of substrates 10, which has not been processed, at an interval along the Z-axis direction.

The carry-in cassette 35 may horizontally accommodate the substrate 10 with the protective tape 14 facing upward to suppress deformation, such as peeling-off, of the protective tape 14. The substrate 10 taken out of the carry-in cassette 35 is inverted and then transferred to the processing unit such as the alignment unit 60.

The carry-out cassette 45 is carried out of the carry-out unit 40 to the outside. The carry-out unit 40 is equipped with a placing plate 41 on which the carry-out cassette 45 is placed. A plurality of placing plates 41 is provided in a row along the Y-axis direction. The number of placing plates 41 is not limited to the illustrated embodiment. The carry-out cassette 45 accommodates a plurality of substrates 10, which has been processed, at an interval along the Z-axis direction.

The transfer path 50 is a passage through which the transfer unit 58 transfers the substrate 10, and is extended, for example, in the Y-axis direction. The transfer path 50 is equipped with a Y-axis guide 51 extended in the Y-axis direction, and a Y-axis slider 52 is movable along the Y-axis guide 51.

The transfer unit 58 is configured to hold the substrate 10 and also move along the transfer path 50 to transfer the substrate 10. The transfer unit 58 may hold the substrate 10 via the frame. The transfer unit 58 is configured to vacuum-attract the substrate 10, but may electrostatically attract the substrate 10. The transfer unit 58 includes the Y-axis slider 52 serving as a transfer base body and moves in the Y-axis direction. The transfer unit 58 can also move in the X-axis direction, the Z-axis direction and the θ direction as well as the Y-axis direction. The transfer unit 58 also includes an inverting mechanism configured to invert the substrate 10.

The transfer unit 58 may include a plurality of holders configured to hold the substrate 10. The plurality of holders may be provided at an interval along the Z-axis direction. The plurality of holders may be separately used for each processing on the substrate 10.

The carry-in unit 30, the carry-out unit 40, the alignment unit 60 and the laser processing unit 100 are provided adjacent to the transfer path 50 when viewed from the vertical direction. For example, a longitudinal direction of the transfer path 50 is the Y-axis direction. On the negative X-axis direction side of the transfer path 50, the carry-in unit 30 and the carry-out unit 40 are provided. Also, on the positive X-axis direction side of the transfer path 50, the alignment unit 60 and the laser processing unit 100 are provided.

Further, the placement and number of processing units such as the alignment unit 60 and the laser processing unit 100 are not limited to the embodiment illustrated in FIG. 2 and can be selected as required. Also, a plurality of processing units may be distributed and integrated in any unit. Hereinafter, each processing unit will be described.

The alignment unit 60 is configured to measure a center position of the substrate 10 and a crystal orientation of the substrate 10 (for example, a direction of a notch 19). For example, the alignment unit 60 includes a substrate holder configured to hold the substrate 10 from below, an imaging unit configured to image the substrate 10 held on the substrate holder and a moving unit configured to move an imaging position where the substrate 10 is imaged by the imaging unit. Also, the crystal orientation of the substrate 10 may be indicated by an orientation flat instead of the notch 19.

The laser processing unit 100 is configured to perform a laser processing on the substrate 10. For example, the laser processing unit 100 performs a laser processing (so-called laser dicing) of dividing the substrate 10 into a plurality of chips. The laser processing unit 100 performs the laser processing on the substrate 10 by irradiating a laser beam LB (see FIG. 6) at an irradiation point on a dividing target line 13 (see FIG. 1) and moving the irradiation point on the dividing target line 13.

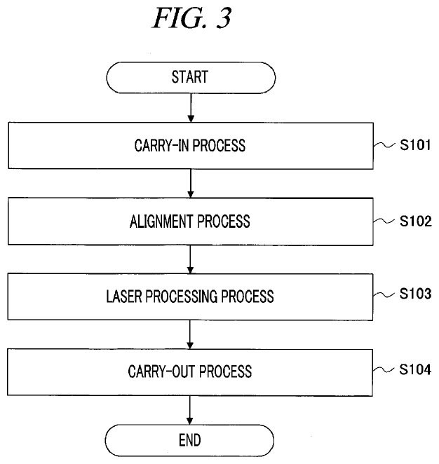

Hereinafter, a substrate processing method using the substrate processing system 1 having the above-described configuration will be described with reference to FIG. 3. FIG. 3 is a flowchart showing a substrate processing method according to the first exemplary embodiment.

As illustrated in FIG. 3, the substrate processing method includes a carry-in process S101, an alignment process S102, a laser processing process S103 and a carry-out process S104. These processes are performed under the control of the controller 20.

In the carry-in process S101, the transfer unit 58 takes the substrate 10 out of the carry-in cassette 35 placed on the carry-in unit 30 and inverts the taken substrate 10, and then, transfers the substrate 10 to the alignment unit 60.

In the alignment process S102, the alignment unit 60 measures the center position of the substrate 10 and the crystal orientation of the substrate 10 (for example, the direction of the notch 19). The positions of the substrate 10 in the X-axis direction, the Y-axis direction and the 0 direction can be adjusted based on the result of the measurement. The substrate 10 whose position has been adjusted is transferred from the alignment unit 60 to the laser processing unit 100 by the transfer unit 58.

In the laser processing process S103, the laser processing unit 100 performs the laser processing on the substrate 10. The laser processing unit 100 performs the laser processing of dividing the substrate 10 into the chips by irradiating the laser beam LB (see FIG. 6) on the irradiation point P1 on the dividing target line 13 (see FIG. 1) and moving the irradiation point P1 (see FIG. 6) on the dividing target line 13.

In the carry-out process S104, the transfer unit 58 transfers the substrate 10 from the laser processing unit 100 to the carry-out unit 40, and then, accommodates the substrate 10 within the carry-out cassette 45 on the carry-out unit 40. The carry-out cassette 45 is carried out of the carry-out unit 40 to the outside.

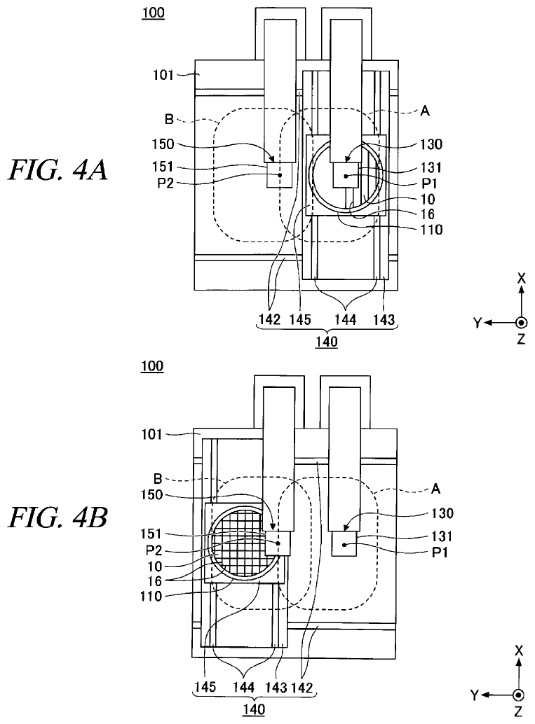

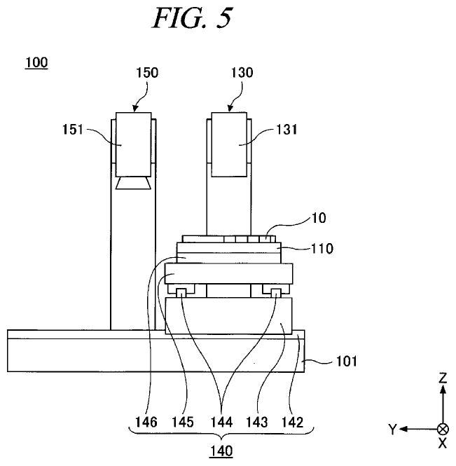

FIG. 4A and FIG. 4B show plan views illustrating the laser processing unit according to the first exemplary embodiment. FIG. 4A is a plan view illustrating a status of the laser processing unit during a processing. FIG. 4B is a plan view illustrating a status of the laser processing unit during an inspection. FIG. 5 is a front view illustrating the laser processing unit according to the first exemplary embodiment. FIG. 6 is a side view illustrating a processing head unit and a substrate holder according to the first exemplary embodiment.

The laser processing unit 100 includes a substrate holder 110 configured to hold the substrate 10, a processing head unit 130 configured to form the irradiation point P1 of the laser beam LB for processing the substrate 10 on a main surface (for example, a second main surface 12) of the substrate 10 held on the substrate holder 110, a substrate moving unit 140 configured to move the substrate holder 110 and the controller 20 configured to control the substrate moving unit 140. Although FIG. 2 illustrates that the controller 20 is provided separately from the laser processing unit 100, the controller 20 may be provided as a part of the laser processing unit 100.

The substrate holder 110 is configured to horizontally hold the substrate 10 from below. As illustrated in FIG. 6, the substrate 10 is placed on an upper surface of the substrate holder 110 in a state where the first main surface 11 protected by the protective tape 14 faces downward. The substrate holder 110 holds the substrate 10 via the protective tape 14. For example, a vacuum chuck may be used as the substrate holder 110, but an electrostatic chuck may also be used.

The processing head unit 130 has a housing 131 accommodating therein an optical system configured to irradiate the laser beam LB toward an upper surface (for example, the second main surface 12) of the substrate 10 from above. The housing 131 accommodates therein a condensing lens 132 configured to condense the laser beam LB. In the present exemplary embodiment, the processing head unit 130 is not configured to be horizontally movable with respect to a fixing table 101, but may be configured to be horizontally movable with respect to the fixing table 101.

The laser beam LB is condensed inside the substrate 10 by, for example, the condensing lens 132 to form a modification layer 15 which serves as a cutting point within the substrate 10. When forming the modification layer 15 within the substrate 10, a laser beam having permeability to the substrate 10 is used. The modification layer 15 is formed by, for example, locally melting and solidifying the inside of the substrate 10.

Also, in the present exemplary embodiment, the laser beam LB forms the modification layer 15 serving as the cutting point within the substrate 10, but may form a laser processing groove in the upper surface of the substrate 10. The laser processing groove may or may not penetrate through the substrate 10 in a plate thickness direction. In this case, a laser beam having absorptivity to the substrate 10 is used.

The substrate moving unit 140 moves the substrate holder 110 with respect to the fixing table 101. The substrate moving unit 140 moves the substrate holder 110 in the X-axis direction, the Y-axis direction and the θ direction. Also, the substrate moving unit 140 may move the substrate holder 110 in the Z-axis direction.

As illustrated in FIG. 4A and FIG. 4B, the substrate moving unit 140 is equipped with Y-axis guides 142 extended in the Y-axis direction and a Y-axis slider 143 which is movable along the Y-axis guides 142. As a driving source for moving the Y-axis slider 143 in the Y-axis direction, a servo motor or the like may be used. A rotational motion of the servo motor is converted into a linear motion of the Y-axis slider 143 by a motion converting mechanism such as a ball screw or the like. Further, the substrate moving unit 140 is equipped with X-axis guides 144 extended in the X-axis direction and an X-axis slider 145 which is movable along the X-axis guides 144. As a driving source for moving the X-axis slider 145 in the X-axis direction, a servo motor or the like may be used. A rotational motion of the servo motor is converted into a linear motion of the X-axis slider 145 by a motion converting mechanism such as a ball screw or the like. Further, the substrate moving unit 140 has a rotation table 146 (see FIG. 5) configured to be rotated in the θ direction. As a driving source for rotating the rotation table 146 in the θ direction, a servo motor or the like may be used.

For example, the Y-axis guides 142 are fixed to the fixing table 101. The Y-axis guides 142 are provided throughout the processing head unit 130 and an inspection unit 150, which will be described below, when viewed from the Z-axis direction. The X-axis guides 144 are fixed to the Y-axis slider 143 which moves along the Y-axis guides 142. The rotation table 146 is provided to be rotatable on the X-axis slider 145 which moves the X-axis guides 144. The substrate holder 110 is fixed to the rotation table 146.

The laser processing unit 100 includes the inspection unit 150 configured to detect the dividing target lines 13 of the substrate 10 held on the substrate holder 110 and processing traces 16 formed on the substrate 10 by the laser beam LB. The dividing target lines 13 of the substrate 10 are set on the streets formed in the lattice shape on the first main surface 11 of the substrate 10. Then, the processing traces 16 of the substrate 10 are formed along the dividing target lines 13.

The inspection unit 150 includes, for example, an imaging unit 151 configured to take an image of the substrate 10 held on the substrate holder 110. In the present exemplary embodiment, the imaging unit 151 is configured not to be horizontally movable with respect to the fixing table 101, but may be configured to be horizontally movable with respect to the fixing table 101. The imaging unit 151 may be configured to be vertically movable with respect to the fixing table 101 in order to adjust a height of the focus of the imaging unit 151.

The imaging unit 151 is provided above the substrate holder 110. The imaging unit 151 images the modification layer 15 formed within the substrate 10 from above the substrate 10 held on the substrate holder 110. Further, the imaging unit 151 images streets formed in advance on a lower surface (for example, the first main surface 11) of the substrate 10 from above the substrate 10 held on the substrate holder 110. In this case, an infrared camera configured to take an infrared image penetrating the substrate 10 may be used as the imaging unit 151.

The imaging unit 151 is configured to convert the image of the substrate 10 into an electrical signal and then transmits the electrical signal to the controller 20. The controller 20 performs an image processing on the image taken by the imaging unit 151 to detect whether there is an abnormality in the laser processing. The abnormality in the laser processing may include, for example, deviation between the processing traces 16 and the dividing target lines 13, chipping, or the like. The image processing may be performed simultaneously with the taking of the image or after the taking of the image.

Herein, the inspection unit 150 may also serve as an alignment unit configured to detect the dividing target lines 13 of the substrate 10 before the laser processing in order to reduce the cost and the installation space. Hereinafter, the inspection unit 150 may also be referred to as “alignment unit 150”.

The imaging unit 151 of the alignment unit 150 takes the image of the substrate 10 before the laser processing and converts the image of the substrate 10 into the electrical signal to transmit the electrical signal to the controller 20. The controller 20 performs the image processing on the image of the substrate 10 taken by the imaging unit 151 before the laser processing to detect the positions of the dividing target lines 13 of the substrate 10. The positions of the dividing target lines 13 may be detected by using known methods such as a method of matching a street pattern formed in advance in the lattice shape on the first main surface 11 of the substrate 10 with a reference pattern, a method of obtaining the center point of the substrate 10 and the direction of the substrate 10 from a plurality of points on an outer periphery of the substrate 10, or the like. The direction of the substrate 10 may be detected from the position of the notch 19 (see FIG. 1) formed in the outer periphery of the substrate 10. Instead of the notch 19, an orientation flat may be used. Thus, the controller 20 may figure out the positions of the dividing target lines 13 of the substrate 10 in a coordinate system fixed to the substrate holder 110. Also, the image processing may be performed simultaneously with the taking of the image or after the taking of the image. On the dividing target lines 13 detected by the alignment unit 150, the irradiation point P1 of the laser beam LB is moved.

Further, in the present exemplary embodiment, the inspection unit 150 also serves as the alignment unit, but may not serve as the alignment unit. That is, the inspection unit 150 may be provided separately from the alignment unit. In this case, the alignment unit may be provided as a part of the laser processing unit 100 or may be provided outside the laser processing unit 100.

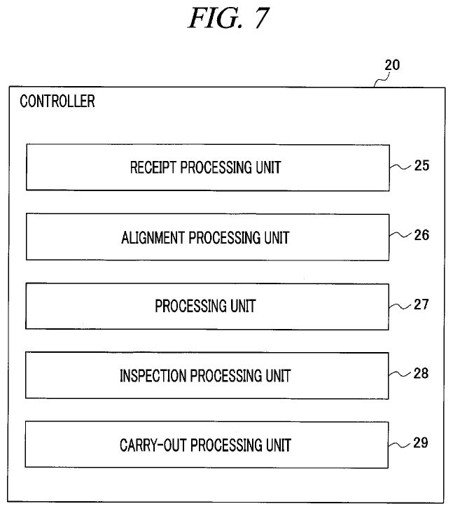

FIG. 7 illustrates components of the controller as functional blocks according to the first exemplary embodiment. The respective functional blocks illustrated in FIG. 7 are conceptual and do not necessarily have to be physically configured as illustrated. All or some of the functional blocks may be functionally or physically distributed and integrated in any unit. All or some of respective processing functions performed in the respective functional blocks may be implemented by the program executed in the CPU, or may be realized as hardware by wired logic.

As illustrated in FIG. 7, the controller 20 is equipped with a receipt processing unit 25, an alignment processing unit 26, a processing unit 27, an inspection processing unit 28, a carry-out processing unit 29, and the like. The receipt processing unit 25 controls the transfer unit 58 to perform a receipt processing of receiving the substrate 10, which has been delivered from the transfer unit 58, with the substrate holder 110. The substrate holder 110 holds the substrate 10 during the receipt processing. The alignment processing unit 26 controls the alignment unit 150 and the substrate moving unit 140 to perform the alignment processing of detecting the dividing target lines 13 of the substrate 10 held on the substrate holder 110. The processing unit 27 controls an oscillator configured to oscillate the laser beam LB and the substrate moving unit 140 to perform a processing of forming the processing traces 16 along the dividing target lines 13 of the substrate 10 held on the substrate holder 110. The inspection processing unit 28 controls the inspection unit 150 and the substrate moving unit 140 to perform the inspection of detecting the dividing target lines 13 and the processing traces 16 of the substrate 10 held on the substrate holder 110. The carry-out processing unit 29 controls the transfer unit 58 to perform the carry-out processing of delivering the substrate 10 held on the substrate holder 110 to the transfer unit 58. The holding of the substrate 10 by the substrate holder 110 is released during the carry-out processing.

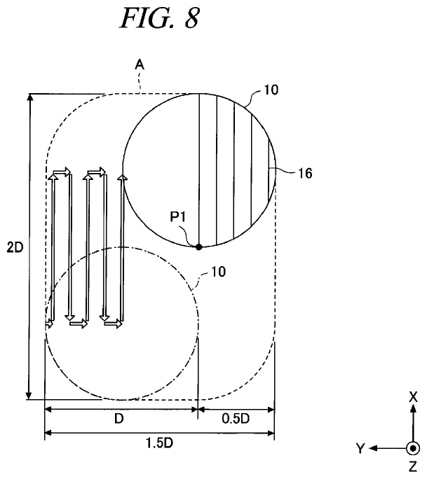

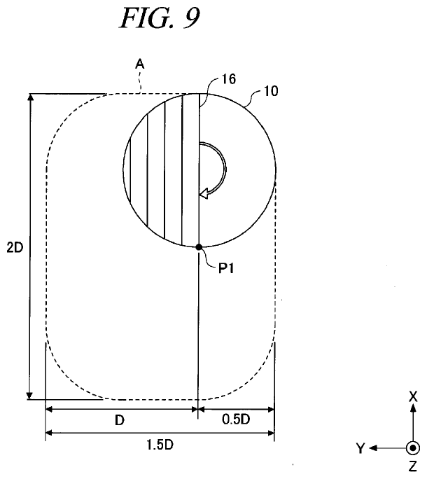

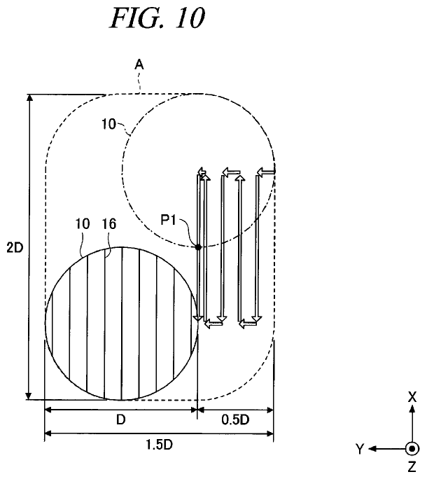

FIG. 8 is a plan view illustrating an example of movement of the substrate in the X-axis direction and the Y-axis direction by the processing unit according to the first exemplary embodiment. FIG. 9 is a plan view illustrating an example of rotation of the substrate around the Z-axis by the processing unit subsequent to FIG. 8. FIG. 10 is a plan view illustrating an example of the movement of the substrate by the processing unit in the X-axis direction and the Y-axis direction subsequent to FIG. 9.

The processing unit 27 (see FIG. 7) moves the substrate holder 110 to move the irradiation point P1 of the laser beam LB on the main surface (for example, the second main surface 12) of the substrate 10 held on the substrate holder 110 in the X-axis direction and the Y-axis direction. The processing unit 27 moves the irradiation point P1 on the dividing target lines 13.

Specifically, the processing unit 27 alternately repeats moving the substrate holder 110 in one direction of the Y-axis (for example, the negative Y-axis direction) to arrange the irradiation point P1 on the dividing target line 13 and moving the substrate holder 110 in the X-axis direction to move the irradiation point P1 on the dividing target line 13. The substrate 10 held on the substrate holder 110 is moved as indicated by white arrows in FIG. 8 from a position indicated by a dashed-dotted line in FIG. 8 to a position indicated by a solid line in FIG. 8. The irradiation point P1 on the main surface of the substrate 10 may be moved so as not to be arranged on a single dividing target line 13 several times in order to reduce a moving path and a moving time thereof. To this end, the processing unit 27 changes a movement direction of the substrate holder 110 in the X-axis direction to be opposite whenever switching the dividing target line 13 on which the irradiation point P1 is arranged. The substrate holder 110 may be moved in the negative X-axis direction or the positive X-axis direction. In this way, the processing traces 16 extended in the X-axis direction (vertical direction in FIG. 8) are formed on a half of the substrate 10 at the negative Y-axis direction side (right side in FIG. 8). Meanwhile, a moving area A in which the substrate 10 is moved has an X-axis directional size which is 2 times a diameter D of the substrate 10 and a Y-axis directional size which is 1.5 times the diameter D of the substrate 10 as shown in FIG. 8. The irradiation point P1 is placed at an X-axis directional center position of the moving area A. The irradiation point P1 is placed not at a Y-axis directional center position of the moving area A, but at a position away from the Y-axis directional center position by a predetermined distance (for example, 0.25 times the diameter D of the substrate 10) at one side of the Y-axis direction.

Then, the processing unit 27 rotates the substrate holder 110 around the Z-axis by n° (n=180+m×360, m is an integer equal to or greater than zero) to change the direction of the substrate 10 held on the substrate holder 110 by 180°. Although FIG. 9 illustrates that a rotation direction of the substrate holder 110 is a clockwise direction, it may be a counterclockwise direction. The direction of the substrate 10 may be changed by 180° regardless of the rotation direction of the substrate holder 110. Thus, an area of the substrate 10 where the processing traces 16 are formed and an area of the substrate 10 where the processing traces 16 are not formed are switched with each other. For example, as illustrated in FIG. 9, the area of the substrate 10 where the processing traces 16 are formed is moved to the left half side of the substrate 10 and the area of the substrate 10 where the processing traces 16 are not formed is moved to the right half side of the substrate 10.

In the present specification, the change of the direction of the substrate 10 by 180° means that the direction of the substrate 10 is changed by 180° within an error range. The error range is, for example, 180°±2°.

Then, the processing unit 27 alternately repeats moving the substrate holder 110 in the other direction of the Y-axis (for example, the positive Y-axis direction) to arrange the irradiation point P1 on the dividing target line 13 and moving the substrate holder 110 in the X-axis direction to move the irradiation point P1 on the dividing target line 13. The substrate 10 held on the substrate holder 110 is moved as indicated by white arrows in FIG. 10 from a position indicated by a dashed-dotted line in FIG. 10 to a position indicated by a solid line in FIG. 10. The irradiation point P1 on the main surface of the substrate 10 may be moved so as not to be arranged on a single dividing target line 13 several times in order to reduce the moving path and the moving time thereof. To this end, the processing unit 27 changes the movement direction of the substrate holder 110 in the X-axis direction to be opposite whenever switching the dividing target line 13 on which the irradiation point P1 is arranged. The substrate holder 110 may be moved in the negative X-axis direction or the positive X-axis direction. In this way, the processing traces 16 extended in the X-axis direction (vertical direction in FIG. 10) are formed on a half of the substrate 10 at the negative Y-axis direction side (right side in FIG. 10). Meanwhile, a moving area A in which the substrate 10 is moved is identical to the moving area A illustrated in FIG. 8.

In this way, the processing traces 16 extended in the X-axis direction are formed at an interval along the Y-axis direction on the entire substrate 10. Herein, each processing trace 16 extended in the X-axis direction may have any one of a dotted line shape and a straight line shape. The processing trace 16 having the dotted line shape is formed using the laser beam LB oscillated in a pulse shape. The processing trace 16 having the straight line shape is formed using the laser beam LB oscillated continuously.

Then, the controller 20 rotates the substrate holder 110 around the Z-axis by 90° and then forms processing traces 16 extended in the X-axis direction at an interval along the Y-axis direction. Thus, the processing traces 16 can be formed along the dividing target lines 13 formed in the lattice shape on the substrate 10 held on the substrate holder 110.

As described above, the processing unit 27 switches the dividing target line 13 and repeats moving the substrate holder 110 in the X-axis direction in order to move the irradiation point P1 on the dividing target line 13. Meanwhile, the processing unit 27 rotates the substrate holder 110 around the Z-axis to change the direction of the substrate 10 held on the substrate holder 110 by 180°. Thus, the Y-axis directional size of the moving area A of the substrate 10, which has been 2 times the diameter D of the substrate 10 conventionally, can be reduced to 1.5 times the diameter D of the substrate 10. Therefore, a Y-axis directional size of the laser processing unit 100 can be reduced, and, thus, the installation space of the laser processing unit 100 can be reduced. Also, the processing unit 27 according to the present exemplary embodiment changes the movement direction of the substrate holder 110 in the Y-axis direction to be opposite direction to arrange the irradiation point P1 on the dividing target line 13 before and after the direction of the substrate 10 is changed by 180°, but may not change the movement direction of the substrate holder 110 to be opposite as described below. In either case, the Y-axis directional size of the moving area A of the substrate 10, which has been 2 times the diameter D of the substrate 10 conventionally, can be reduced to 1.5 times the diameter D of the substrate 10.

Further, when the processing unit 27 according to the present exemplary embodiment moves the substrate holder 110 in one direction of the Y-axis (for example, the negative Y-axis direction or the positive Y-axis direction), the processing unit 27 does not move the processing head unit 130 in the Y-axis direction, but may move the processing head unit 130 in the other direction of the Y-axis (for example, the positive Y-axis direction or the negative Y-axis direction). In this case, the Y-axis directional size of the moving area A of the substrate 10 can be further reduced.

Furthermore, the processing unit 27 according to the present exemplary embodiment moves the substrate holder 110 in the negative Y-axis direction before the direction of the substrate 10 held on the substrate holder 110 is changed by 180°, but may move the substrate holder 110 in the positive Y-axis direction. In the latter case, the processing unit 27 moves the substrate holder 110 in the negative Y-axis direction after the direction of the substrate 10 held on the substrate holder 110 is changed by 180°.

Also, the processing unit 27 according to the present exemplary embodiment moves the irradiation point P1 on the dividing target lines 13 (see FIG. 1) extended in the X-axis direction as illustrated in FIG. 8, but can move the irradiation point P1 on the dividing target lines 13 extended in the Y-axis direction. If the technology of the present disclosure is applied to the latter case, the X-axis directional size of the moving area A of the substrate 10, which has been 2 times the diameter D of the substrate 10 conventionally, can be reduced to 1.5 times the diameter D of the substrate 10.

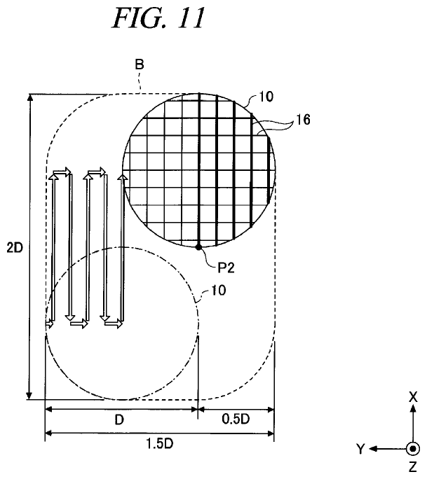

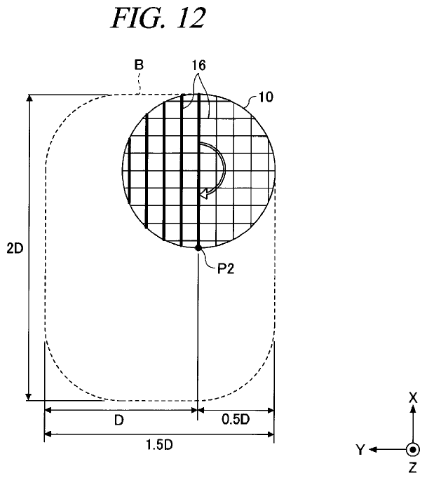

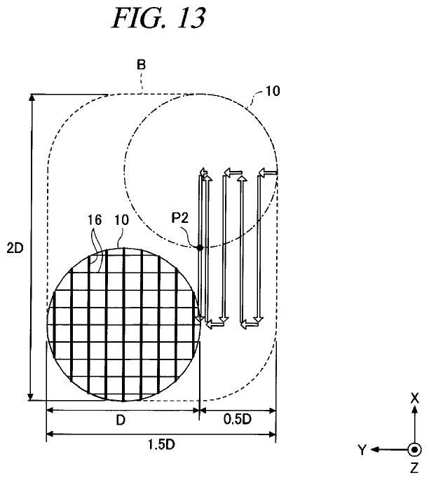

FIG. 11 is a plan view illustrating an example of movement of the substrate by the inspection processing unit in the X-axis direction and the Y-axis direction according to the first exemplary embodiment. FIG. 12 is a plan view illustrating an example of rotation of the substrate around the Z-axis by the inspection processing unit subsequent to FIG. 11. FIG. 13 is a plan view illustrating an example of the movement of the substrate by the inspection processing unit in the X-axis direction and the Y-axis direction subsequent to FIG. 12. In FIG. 11 to FIG. 13, the processing traces 16 shown by bold lines are inspected ones and the processing traces 16 shown by thin lines are uninspected ones.

The inspection processing unit 28 (see FIG. 7) moves the substrate holder 110, so that the inspection unit 150 can move a detection point P2 (see FIG. 4A and FIG. 4B) for detecting the processing trace 16 in the X-axis direction and the Y-axis direction on the main surface (for example, the second main surface 12) of the substrate 10 held on the substrate holder 110. The inspection processing unit 28 moves the detection point P2 on the dividing target lines 13 in the same way as the processing unit 27.

Specifically, the inspection processing unit 28 alternately repeats moving the substrate holder 110 in one direction of the Y-axis (for example, the negative Y-axis direction) to arrange the detection point P2 on a dividing target line 13 and moving the substrate holder 110 in the X-axis direction to move the detection point P2 on the dividing target line 13. The substrate 10 held on the substrate holder 110 is moved as indicated by white arrows in FIG. 11 from a position indicated by a dashed-dotted line in FIG. 11 to a position indicated by a solid line in FIG. 11. The detection point P2 on the main surface of the substrate 10 may be moved so as not to be arranged on a single dividing target line 13 several times in order to reduce a moving path and a moving time thereof. To this end, the inspection processing unit 28 changes a movement direction of the substrate holder 110 in the X-axis direction to be opposite whenever switching the dividing target line 13 on which the detection point P2 is arranged. The substrate holder 110 may be moved in the negative X-axis direction or the positive X-axis direction. In this way, the inspection of the processing traces 16 extended in the X-axis direction is performed on a half of the substrate 10 at the negative Y-axis direction side (right side in FIG. 11). Meanwhile, a moving area B in which the substrate 10 is moved has an X-axis directional size which is 2 times the diameter D of the substrate 10 and a Y-axis directional size which is 1.5 times the diameter D of the substrate 10 as shown in FIG. 11. The detection point P2 is placed at an X-axis directional center position of the moving area B. The detection point P2 is placed not at a Y-axis directional center position of the moving area B, but at a position away from the Y-axis directional center position by a predetermined distance (for example, 0.25 times the diameter D) at one side of the Y-axis direction.

Then, the inspection processing unit 28 rotates the substrate holder 110 around the Z-axis by n° (n=180+m×360, m is an integer equal to or greater than zero) to change the orientation of the substrate 10 held on the substrate holder 110 by 180°. Although FIG. 12 illustrates that a rotation direction of the substrate holder 110 is a clockwise direction, it may be a counterclockwise direction. The direction of the substrate 10 may be changed by 180° regardless of the rotation direction of the substrate holder 110. Thus, an area of the substrate 10 where the inspection of the processing traces 16 extended in the X-axis direction has been performed and an area of the substrate 10 where the inspection of the processing traces 16 extended in the X-axis direction has not been performed are switched with each other. For example, as illustrated in FIG. 12, the area of the substrate 10 where the inspection of the processing traces 16 extended in the X-axis direction has been performed is moved to the left half side of the substrate 10 and the area of the substrate 10 where the inspection of the processing traces 16 extended in the X-axis direction has not been performed is moved to the right half side of the substrate 10.

Then, the inspection processing unit 28 alternately repeats moving the substrate holder 110 in the other direction of the Y-axis (for example, the positive Y-axis direction) to arrange the detection point P2 on the dividing target line 13 and moving the substrate holder 110 in the X-axis direction to move the detection point P2 on the dividing target line 13. The substrate 10 held on the substrate holder 110 is moved as indicated by white arrows in FIG. 13 from a position indicated by a dashed-dotted line in FIG. 13 to a position indicated by a solid line in FIG. 13. The detection point P2 on the main surface of the substrate 10 may be moved so as not to be arranged on a single dividing target line 13 several times in order to reduce the moving path and the moving time thereof. To this end, the inspection processing unit 28 changes the movement direction of the substrate holder 110 in the X-axis direction to be opposite whenever switching the dividing target line 13 on which the detection point P2 is arranged. The substrate holder 110 may be moved in the negative X-axis direction or the positive X-axis direction. In this way, the inspection of the processing traces 16 extended in the X-axis direction is performed on a half of the substrate 10 at the negative Y-axis direction side (right side in FIG. 13). Meanwhile, a moving area B in which the substrate 10 is moved is identical to the moving area B illustrated in FIG. 11.

In this way, the inspection of the processing traces 16 extended in the X-axis direction is performed on the entire substrate 10. In the inspection, the occurrence of the deviation between the processing traces 16 and the dividing target lines 13, chipping, and the like are inspected.

Then, the controller 20 rotates the substrate holder 110 around the Z-axis by 90° and then inspects processing traces 16 extended in the X-axis direction. Thus, the inspections of the processing traces 16 can be performed along the dividing target lines 13 formed in the lattice shape on the substrate 10 held on the substrate holder 110.

As described above, the inspection processing unit 28 switches the dividing target line 13 and repeats moving the substrate holder 110 in the X-axis direction in order to move the detection point P2 on the dividing target line 13. Meanwhile, the inspection processing unit 28 rotates the substrate holder 110 around the Z-axis to change the direction of the substrate 10 held on the substrate holder 110 by 180°. Thus, the Y-axis directional size of the moving area B of the substrate 10, which has been 2 times the diameter D of the substrate 10 conventionally, can be reduced to 1.5 times the diameter D of the substrate 10. Therefore, the Y-axis directional size of the laser processing unit 100 can be reduced, and, thus, the installation space of the laser processing unit 100 can be reduced. Also, the inspection processing unit 28 according to the present exemplary embodiment changes the movement direction of the substrate holder 110 in the Y-axis direction to be opposite to arrange the detection point P2 on the dividing target line 13 before and after the direction of the substrate 10 is changed by 180°, but may not change the movement direction of the substrate holder 110 to be opposite as described below. In either case, the Y-axis directional size of the moving area B of the substrate 10, which has been 2 times the diameter D of the substrate 10 conventionally, can be reduced to 1.5 times the diameter D of the substrate 10.

Further, when the inspection processing unit 28 according to the present exemplary embodiment moves the substrate holder 110 in one direction of the Y-axis (for example, the negative Y-axis direction or the positive Y-axis direction), the inspection processing unit 28 does not move the inspection unit 150 in the Y-axis direction, but may move the inspection unit 150 in the other direction of the Y-axis (for example, the positive Y-axis direction or the negative Y-axis direction). In this case, the Y-axis directional size of the moving area B of the substrate 10 can be further reduced.

Furthermore, the inspection processing unit 28 according to the present exemplary embodiment moves the substrate holder 110 in the negative Y-axis direction before the direction of the substrate 10 held on the substrate holder 110 is changed by 180°, but may move the substrate holder 110 in the positive Y-axis direction. In the latter case, the inspection processing unit 28 moves the substrate holder 110 in the negative Y-axis direction after the direction of the substrate 10 held on the substrate holder 110 is changed by 180°.

Also, the inspection processing unit 28 according to the present exemplary embodiment moves the detection point P2 on the dividing target lines 13 (see FIG. 1) extended in the X-axis direction as illustrated in FIG. 11, but can move the detection point P2 on the dividing target lines 13 extended in the Y-axis direction. If the technology of the present disclosure is applied to the latter case, the X-axis directional size of the moving area B of the substrate 10, which has been 2 times the diameter D of the substrate 10 conventionally, can be reduced to 1.5 times the diameter D of the substrate 10.

Meanwhile, as illustrated in FIG. 4A and FIG. 4B, the processing head unit 130 and the inspection unit 150 are provided at an interval along the Y-axis direction. Thus, the substrate moving unit 140 has the Y-axis guides 142 extended and provided throughout the processing head unit 130 and the inspection unit 150 when viewed from the Z-axis direction. For this reason, by moving the substrate holder 110 along the Y-axis guides 142, it is possible to consecutively perform the processing of forming the processing traces 16 on the substrate 10 and the inspection of inspecting the processing traces 16 on the substrate 10 without separating the substrate 10 from the substrate holder 110. Therefore, it is possible to reduce the processing time.

As illustrated in FIG. 4A and FIG. 4B, a part of the moving area A of the substrate 10 held on the substrate holder 110 and moved by the processing unit 27 and a part of the moving area B of the substrate 10 held on the substrate holder 110 and moved by the inspection processing unit 28 are overlapped with each other in the Y-axis direction. As the overlapped area increases, the Y-axis directional size of the laser processing unit 100 can be reduced, and, thus, the installation space of the laser processing unit 100 can be reduced. For this reason, as illustrated in FIG. 4A and FIG. 4B, if there is a single substrate holder 110 that moves along the pair of Y-axis guides 142, a distance between the processing unit 27 and the inspection processing unit 28 in the Y-axis direction decreases as much as possible.

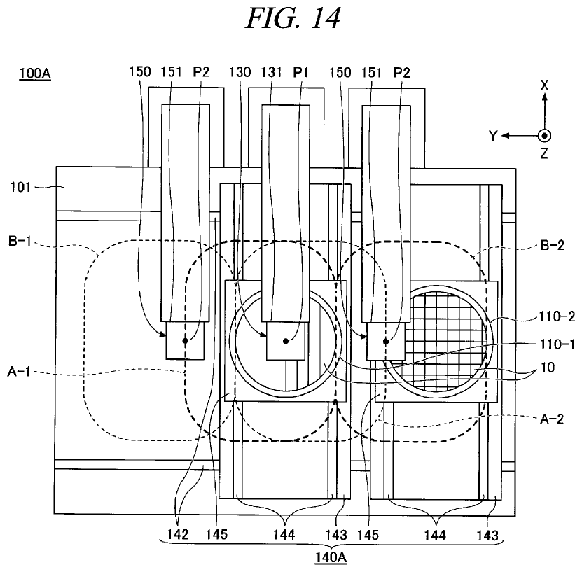

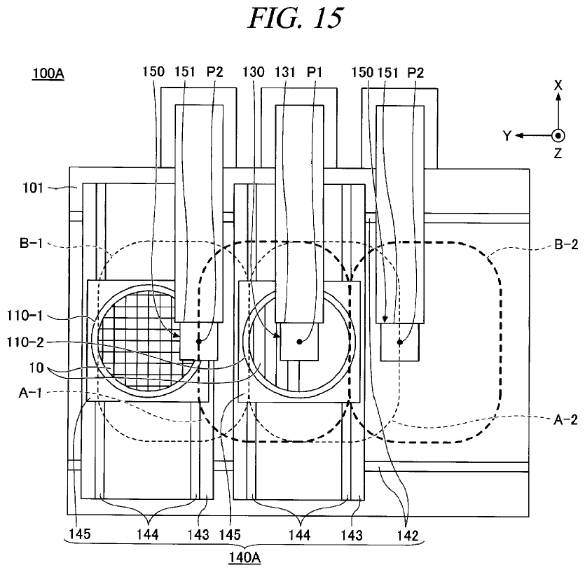

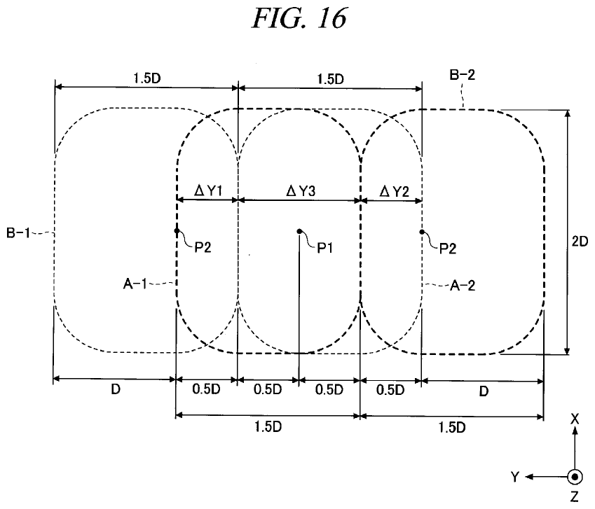

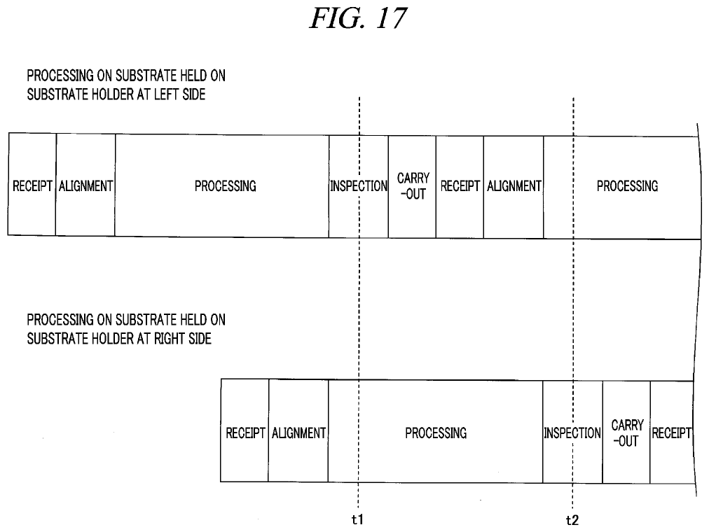

FIG. 14 is a plan view illustrating a laser processing unit according to a second exemplary embodiment and illustrating a status at a time t2 shown in FIG. 17. FIG. 15 is a plan view illustrating the laser processing unit according to the second exemplary embodiment and illustrating a status at a time t1 shown in FIG. 17. FIG. 16 is a plan view illustrating a moving area of each of a plurality of substrates held by a plurality of substrate holders, respectively, according to the second exemplary embodiment. Hereinafter, descriptions will be made focusing on a difference between the present exemplary embodiment and the first exemplary embodiment.

A laser processing unit 100A includes a plurality of (for example, two) inspection units 150. The plurality of inspection units 150 is provided at an interval along the Y-axis direction and a single processing head unit 130 is provided between two adjacent inspection units 150 as illustrated in FIG. 14 and FIG. 15. The Y-axis guides 142 are provided throughout the two adjacent inspection units 150 when viewed from the Z-axis direction. A substrate moving unit 140A independently moves a plurality of (for example, two) substrate holders 110-1 and 110-2 along the Y-axis guides 142.

As for the substrate 10 held on the substrate holder 110-1 at the positive Y-axis direction side (hereinafter, also referred to as “left side”), a part of a moving area A-1 (hereinafter, also referred to as “moving area A-1 during the processing”) of the substrate 10 moved by the processing unit 27 and a part of a moving area B-1 (hereinafter, also referred to as “moving area B-1 during the inspection”) of the substrate 10 moved by the inspection processing unit 28 are overlapped with each other as in the first exemplary embodiment. The moving area A-1 during the processing has an X-axis directional size which is 2 times the diameter D of the substrate 10 and a Y-axis directional size which is 1.5 times the diameter D of the substrate 10 as in the first exemplary embodiment. The moving area B-1 during the inspection has an X-axis directional size which is 2 times the diameter D of the substrate 10 and a Y-axis directional size which is 1.5 times the diameter D of the substrate 10 as in the first exemplary embodiment. An overlapped part between the moving area A-1 during the processing and the moving area B-1 during the inspection has a Y-axis directional size ΔY1 which is not particularly limited but may be, for example, 0.5 times the diameter D of the substrate 10.

Likewise, as for the substrate 10 held on the substrate holder 110-2 at the negative Y-axis direction side (hereinafter, also referred to as “right side”), a part of a moving area A-2 (hereinafter, also referred to as “moving area A-2 during the processing”) of the substrate 10 moved by the processing unit 27 and a part of a moving area B-2 (hereinafter, also referred to as “moving area B-2 during the inspection”) of the substrate 10 moved by the inspection processing unit 28 are overlapped with each other as in the first exemplary embodiment. The moving area A-2 during the processing has an X-axis directional size which is 2 times the diameter D of the substrate 10 and a Y-axis directional size which is 1.5 times the diameter D of the substrate 10 as in the first exemplary embodiment. The moving area B-2 during the inspection has an X-axis directional size which is 2 times the diameter D of the substrate 10 and a Y-axis directional size which is 1.5 times the diameter D of the substrate 10 as in the first exemplary embodiment. An overlapped part between the moving area A-2 during the processing and the moving area B-2 during the inspection has a Y-axis directional size ΔY2 which is not particularly limited but may be, for example, 0.5 times the diameter D of the substrate 10.

As illustrated in FIG. 16, a part of the moving area A-1 during the processing of the substrate 10 held on the substrate holder 110-1 at the left side and a part of the moving area A-2 during the processing of the substrate 10 held on the substrate holder 110-2 at the right side are overlapped with each other. Therefore, a Y-axis directional size of the laser processing unit 100A can be reduced, and, thus, the installation space of the laser processing unit 100A can be reduced. An overlapped part between the moving area A-1 during the processing and the moving area A-2 during the processing has a Y-axis directional size ΔY3 which is not particularly limited but may be, for example, equal to the diameter D of the substrate 10.

Further, in the present exemplary embodiment, a guide for guiding the substrate holder 110-1 at the left side along the Y-axis direction and a guide for guiding the substrate holder 110-2 at the right side along the Y-axis direction are identical to each other, but may be different from each other. A part of the moving area A-1 during the processing of the substrate 10 held on the substrate holder 110-1 at the left side and a part of the moving area A-2 during the processing of the substrate 10 held on the substrate holder 110-2 at the right side just need to be overlapped with each other.

FIG. 17 is a time chart provided to explain a processing of a controller according to the second exemplary embodiment. FIG. 17 shows the timings of the processing on the substrate 10 held on the substrate holder 110-1 at the left side and the processing on the substrate 10 held on the substrate holder 110-2 at the right side. The controller 20 replaces the substrate 10 and repeats a series of processings on a substrate 10. The series of processings may include, for example, a receipt processing, an alignment processing, a processing, an inspection processing and a carry-out processing.

As illustrated in FIG. 17, the controller 20 may perform a pre-processing (for example, receipt processing or alignment processing) of the processing of the substrate 10 held on the substrate holder 110-2 at the right side during the processing of the substrate 10 held on the substrate holder 110-1 at the left side. Also, the controller 20 may perform a post-processing (for example, inspection processing or carry-out processing) of the processing of the substrate 10 held on the substrate holder 110-2 at the right side during the processing of the substrate 10 held on the substrate holder 110-1 at the left side. By simultaneously performing different processings on the substrates 10, it is possible to improve the throughput of the laser processing unit 100A.

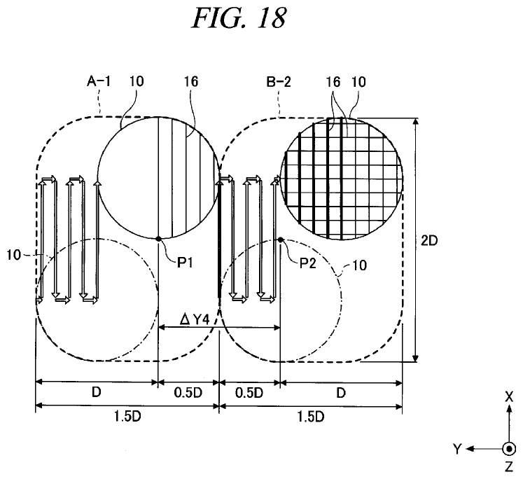

FIG. 18 is a plan view illustrating a positional relationship between the moving area of the substrate held by the substrate holder at the left side during the processing and the moving area of the substrate held by the substrate holder at the right side during the inspection according to the second exemplary embodiment. In FIG. 18, the processing traces 16 shown by bold lines are inspected ones and the processing traces 16 shown by thin lines are uninspected ones.

As illustrated in FIG. 18, the inspection processing of the substrate 10 held on the substrate holder 110-2 at the right side is performed during the processing of the substrate 10 held on the substrate holder 110-1 at the left side. In this case, the substrate holder 110-1 at the left side and the substrate holder 110-2 at the right side are moved independently of each other. A Y-axis directional distance ΔY4 between the detection point P2 of the inspection unit 150 at the right side and the irradiation point P1 of the processing head unit 130 is equal to or greater than the diameter D of the substrate 10 such that the substrate holder 110-1 at the left side and the substrate holder 110-2 at the right side do not interfere with each other. Further, in FIG. 18, ΔY4 is equal to D.

Further, as illustrated in FIG. 17, the controller 20 may perform the pre-processing (for example, receipt processing or alignment processing) of the processing of the substrate 10 held on the substrate holder 110-1 at the left side during the processing of the substrate 10 held on the substrate holder 110-2 at the right side. Also, the controller 20 may perform the post-processing (for example, inspection processing or carry-out processing) of the processing of the substrate 10 held on the substrate holder 110-1 at the left side during the processing of the substrate 10 held on the substrate holder 110-2 at the right side. By simultaneously performing different processings on the substrates 10, it is possible to improve the throughput of the laser processing unit 100A.

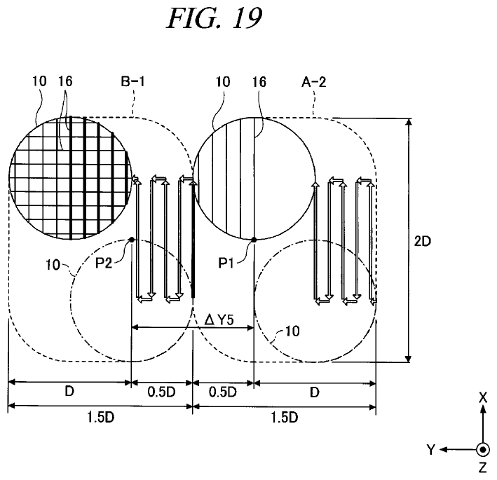

FIG. 19 is a plan view illustrating the positional relationship between the moving area of the substrate held on the substrate holder at the left side during the inspection and the moving area of the substrate held on the substrate holder at the right side during the processing according to the second exemplary embodiment. In FIG. 19, the processing traces 16 shown by bold lines are inspected ones and the processing traces 16 shown by thin lines are uninspected ones.

As illustrated in FIG. 19, the inspection processing of the substrate 10 held on the substrate holder 110-1 at the left side is performed during the processing of the substrate 10 held on the substrate holder 110-2 at the right side. In this case, the substrate holder 110-1 at the left side and the substrate holder 110-2 at the right side are moved independently of each other. A Y-axis directional distance ΔY5 between the detection point P2 of the inspection unit 150 at the left side and the irradiation point P1 of the processing head unit 130 is equal to or greater than the diameter D of the substrate 10 such that the substrate holder 110-1 at the left side and the substrate holder 110-2 at the right side do not interfere with each other. Further, in FIG. 19, ΔY5 is equal to D.

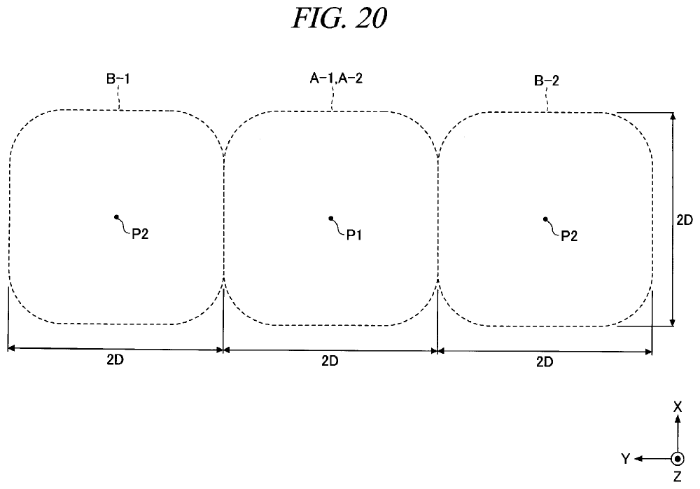

FIG. 20 is a plan view illustrating a moving area of each of a plurality of substrates held by a plurality of substrate holders, respectively, according to a comparative example. In the present comparative example, each of the moving areas A-1 and A-2 during the processing of the substrate 10 has an X-axis directional size which is 2 times the diameter D of the substrate 10 and a Y-axis directional size which is 2 times the diameter of the substrate 10 as in the conventional case. Also, in the present comparative example, each of the moving areas B-1 and B-2 during the inspection of the substrate 10 has an X-axis directional size which is 2 times the dimeter D of the substrate 10 and a Y-axis directional size which is 2 times the diameter D of the substrate 10 as in the conventional case.

In the present comparative example, unlike the second exemplary embodiment, the two moving areas A-1 and A-2 completely overlap with each other. At the left side of the two moving areas A-1 and A-2 which completely overlap with each other, the moving area B-1 is provided to be connected to these two moving areas A-1 and A-2. Also, at the right side of the two moving areas A-1 and A-2 which completely overlap with each other, the moving area B-2 is provided to be connected to these two moving areas A-2.

Further, in the present comparative example, unlike the second exemplary embodiment, the irradiation point P1 is positioned at the center of the two moving areas A-1 and A-2 which completely overlap with each other. Furthermore, the detection point P2 is positioned at the center of the moving area B-1 at the left side. Besides, the detection point P2 is positioned at the center of the moving area B-2 at the right side.

In the present comparative example, as in second exemplary embodiment, while the processing is performed on the substrate 10 in the moving area A-1, the inspection processing is performed on another substrate 10 in the moving area B-2. Also, while the processing is performed on the substrate 10, the inspection processing is performed on another substrate 10 in the moving area B-1.

In the present comparative example, as illustrated in FIG. 20, the entire area including the four moving areas B-1, A-1, A-2 and B-2 has an X-axis directional size which is 2 times the diameter D of the substrate 10 and a Y-axis directional size which is 6 times the diameter D of the substrate 10.

Meanwhile, according to the second exemplary embodiment, the entire area including the four moving areas B-1, A-1, A-2 and B-2 has an X-axis directional size which is 2 times the diameter D of the substrate 10 and a Y-axis directional size which is 4 times the diameter D of the substrate 10 as illustrated in FIG. 16. As such, according to the second exemplary embodiment, the Y-axis directional size of the laser processing unit 100A can be reduced as compared with the comparative example.

Although the exemplary embodiments of the laser processing device and the laser processing method have been described above, the present disclosure is not limited to the above-described exemplary embodiments. Various changes, modifications, substitutions, additions, deletions and combinations may be made within the scope of the claims. Of course, such changes, modifications, substitutions, additions, deletions and combinations belong to the technical scope of the present disclosure.

As illustrated in FIG. 8 to FIG. 10, the processing unit 27 changes the movement direction of the substrate holder 110 in the Y-axis direction to be opposite to arrange the irradiation point P1 on the dividing target line 13 before and after the direction of the substrate 10 is changed by 180°, but may not change the movement direction as described below.

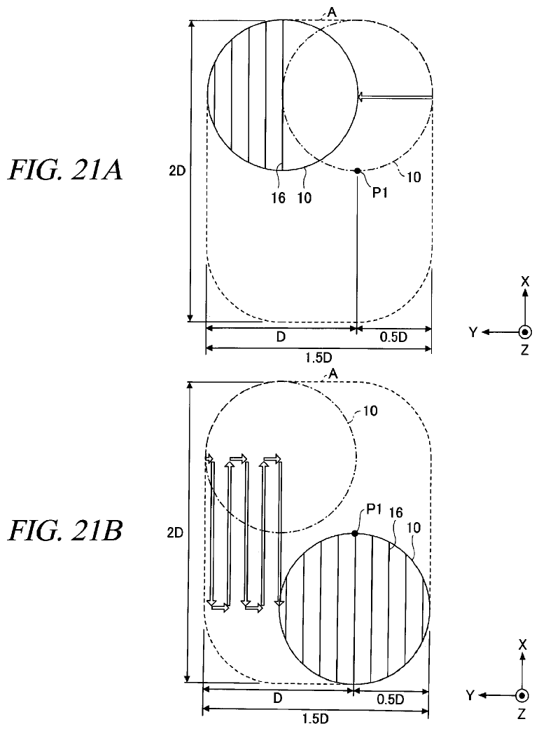

FIG. 21A and FIG. 21B are plan views illustrating a modification example of the movement of the substrate by the processing unit in the X-axis direction and the Y-axis direction subsequent to FIG. 9. FIG. 21A is a plan view illustrating that the substrate is moved in the positive Y-axis direction as preparation before processing the right half side of the substrate according to the modification example. FIG. 21B is a plan view illustrating that the substrate is moved in the X-axis direction and the Y-axis direction during the processing on the right half side of the substrate according to the modification example.

The processing unit 27 changes the direction of the substrate 10 by 180° as illustrated in FIG. 9 and then moves the substrate 10 in the positive Y-axis direction as indicated by white arrows in FIG. 21A from a position indicated by a dashed-dotted line in FIG. 21A to a position indicated by a solid line in FIG. 21A. Thereafter, the processing unit 27 alternately repeats moving the substrate holder 110 in the negative Y-axis direction to arrange the irradiation point P1 on the dividing target line 13 and moving the substrate holder 110 in the X-axis direction to move the irradiation point P1 on the dividing target line 13. The substrate 10 held on the substrate holder 110 is moved as indicated by white arrows in FIG. 21B from a position indicated by a dashed-dotted line in FIG. 21B to a position indicated by a solid line in FIG. 21B. The irradiation point P1 on the main surface of the substrate 10 may be moved so as not to be arranged on a single dividing target line 13 several times in order to reduce the moving path and the moving time thereof. To this end, the processing unit 27 changes the movement direction of the substrate holder 110 in the X-axis direction to be opposite whenever switching the dividing target line 13 on which the irradiation point P1 is arranged. The substrate holder 110 may be moved in the negative X-axis direction or the positive X-axis direction. In this way, the processing traces 16 extended in the X-axis direction (vertical direction in FIG. 21A and FIG. 21B) are formed on a half of the substrate 10 at the negative Y-axis direction side (right side in FIG. 21A and FIG. 21B). Meanwhile, a moving area A in which the substrate 10 is moved is identical to the moving area A illustrated in FIG. 8. Therefore, even in the present modification example, a Y-axis directional size of the moving area A of the substrate 10 which has been 2 times the diameter D of the substrate 10 can be reduced to 1.5 times the diameter D of the substrate 10.

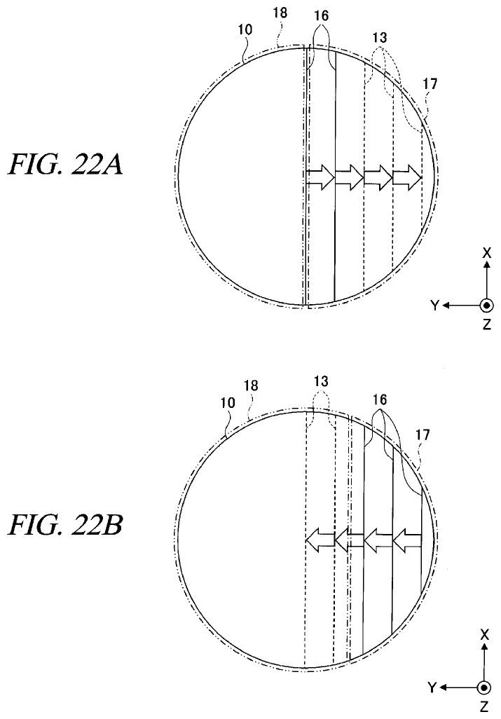

FIG. 22A and FIG. 22B are plan views illustrating two examples of expansion of the substrate, which is caused by formation of the processing traces, while the processing traces extended in the X-axis direction are formed at an interval along the Y-axis direction. If the substrate 10 includes a silicon wafer and the processing trace 16 is formed on the silicon wafer, single crystalline silicon in the processing trace 16 is modified to polycrystalline silicon by the irradiation of the laser beam LB, so that the volume thereof is locally expanded. The direction of the expansion is the Y-axis direction orthogonal to the processing trace 16 and is opposite (i.e., the negative Y-axis direction in FIG. 22A and FIG. 22B) to a direction from the processing trace 16 toward a Y-axis directional center of the substrate 10. The Y-axis directional center of the substrate 10 is line-symmetrically restricted by the substrate holder 110 and thus hardly deviated by the expansion of the substrate 10 as the processing trace 16 is formed.

In FIG. 22A and FIG. 22B, an area 17 surrounded by a dashed-dotted line refers to an area where deviation occurs by the expansion of the substrate 10 when the processing trace 16 is formed. In the area 17, a position after the expansion is deviated from a position before the expansion toward the outside (the negative Y-axis direction in FIG. 22A and FIG. 22B) in a diametric direction of the substrate 10. Also, in FIG. 22A and FIG. 22B, an area 18 surrounded by a dashed double-dotted line refers to an area where the deviation substantially does not occur by the expansion of the substrate 10 when the processing trace 16 is formed.

FIG. 22A is a plan view illustrating an example of the expansion of the substrate while the processing traces 16 are formed sequentially from the Y-axis directional center of the substrate 10 toward a Y-axis directional edge of the substrate 10. As illustrated in FIG. 22A, when the processing traces 16 are formed sequentially from the Y-axis directional center of the substrate 10 toward the Y-axis directional edge of the substrate 10, a dividing target line 13, which is deviated from the Y-axis directional center of the substrate 10 and is formed before the processing traces 16 are formed, is placed in the area 17 where the deviation occurs. For this reason, the accuracy in overlap between the processing traces 16 and the dividing target lines 13 is affected by the expansion of the substrate 10.

FIG. 22B is a plan view illustrating an example of the expansion of the substrate while the processing traces 16 are formed sequentially from the Y-axis directional edge of the substrate 10 toward the Y-axis directional center of the substrate 10. As illustrated in FIG. 22B, when the processing traces 16 are formed sequentially from the Y-axis directional edge of the substrate 10 toward the Y-axis directional center of the substrate 10, a dividing target line 13 formed before the processing traces 16 are formed is placed in the area 18 where the deviation substantially does not occur. For this reason, the accuracy in overlap between the processing traces 16 and the dividing target lines 13 is high.

When processing the right half side of the substrate 10 as illustrated in FIG. 21B, the processing traces 16 are formed sequentially from the Y-axis directional edge of the substrate 10 toward the Y-axis directional center of the substrate 10. For this reason, as for the right half side of the substrate 10, the accuracy in overlap between the processing traces 16 and the dividing target lines 13 is high.

Before processing the right half side of the substrate 10, the processing on the right half side of the substrate 10 illustrated in FIG. 8 is performed. In this processing, the processing traces 16 are formed sequentially from the Y-axis directional edge of the substrate 10 toward the Y-axis directional center of the substrate 10. For this reason, as for the entire surface of the substrate 10, the accuracy in overlap between the processing traces 16 and the dividing target lines 13 is high.

Therefore, if the substrate holder 110 is moved in the same direction of the Y-axis to arrange the detection point P2 on the dividing target line 13 before and after the direction of the substrate 10 is changed by 180° as in the modification example illustrated in FIG. 21A and FIG. 21B, the accuracy in overlap between the processing traces 16 and the dividing target lines 13 is high on the entire surface of the substrate 10.

Meanwhile, if the movement direction of the substrate holder 110 in the Y-axis direction is changed to be opposite to arrange the detection point P2 on the dividing target line 13 before and after the direction of the substrate 10 is changed by 180° as in the exemplary embodiment illustrated in FIG. 8 to FIG. 10, the movement of the substrate 10 illustrated in FIG. 21A can be omitted. Therefore, it is possible to reduce the processing time.

Although FIG. 22A and FIG. 22B illustrates that the processing traces extended in the X-axis direction are formed at the interval along the Y-axis direction, the processing traces extended in the Y-axis direction may be formed at an interval along the X-axis direction. In this case, if the processing traces 16 are formed sequentially from the Y-axis directional edge of the substrate 10 toward the Y-axis directional center of the substrate 10, the accuracy in overlap between the processing traces 16 and the dividing target lines 13 is high.

As illustrated in FIG. 11 to FIG. 13, the inspection processing unit 28 changes the movement direction of the substrate holder 110 in the Y-axis direction to be opposite to arrange the detection point P2 on the dividing target line 13 before and after the direction of the substrate 10 is changed by 180°, but may not change the movement direction as described below.

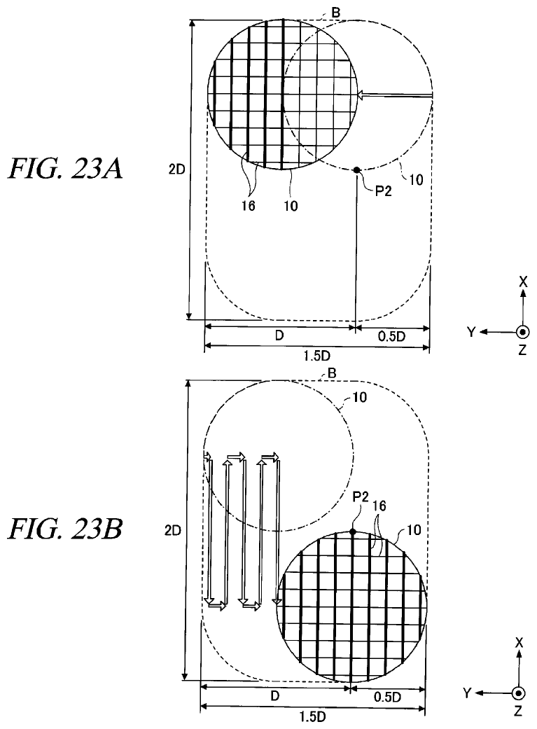

FIG. 23A and FIG. 23B are plan views illustrating a modification example of the movement of the substrate by the processing unit in the X-axis direction and the Y-axis direction subsequent to FIG. 12. FIG. 23A is a plan view illustrating that the substrate is moved in the positive Y-axis direction as preparation before inspecting the right half side of the substrate according to the modification example. FIG. 23B is a plan view illustrating that the substrate is moved in the X-axis direction and the Y-axis direction during the inspection on the right half side of the substrate according to the modification example.

The inspection processing unit 28 changes the direction of the substrate 10 by 180° as illustrated in FIG. 12 and then moves the substrate 10 in the positive Y-axis direction as indicated by white arrows in FIG. 23A from a position indicated by a dashed-dotted line in FIG. 23A to a position indicated by a solid line in FIG. 23A. Thereafter, the inspection processing unit 28 alternately repeats moving the substrate holder 110 in the negative Y-axis direction to arrange the detection point P2 on the dividing target line 13 and moving the substrate holder 110 in the X-axis direction to move the detection point P2 on the dividing target line 13. The substrate 10 held on the substrate holder 110 is moved as indicated by white arrows in FIG. 23B from a position indicated by a dashed-dotted line in FIG. 23B to a position indicated by a solid line in FIG. 23B. The detection point P2 on the main surface of the substrate 10 may be moved so as not to be arranged on a single dividing target line 13 several times in order to reduce the moving path and the moving time thereof. To this end, the inspection processing unit 28 changes the movement direction of the substrate holder 110 in the X-axis direction to be opposite whenever switching the dividing target line 13 on which the detection point P2 is arranged. The substrate holder 110 may be moved in the negative X-axis direction or the positive X-axis direction. In this way, the inspection of the processing traces 16 extended in the X-axis direction is performed on the half of the substrate 10 at the negative Y-axis direction side (right side in FIG. 23A and FIG. 23B). Meanwhile, a moving area B in which the substrate 10 is moved is identical to the moving area B illustrated in FIG. 11. Therefore, even in the present modification example, a Y-axis directional size of the moving area B of the substrate 10, which has been 2 times the diameter D of the substrate 10 conventionally, can be reduced to 1.5 times the diameter D of the substrate 10.

The alignment processing unit 26 moves the substrate holder 110 to move the detection point P2 for detecting the dividing target lines 13 by the alignment unit 150 in the X-axis direction and the Y-axis direction on the main surface (for example, the first main surface 11) of the substrate 10 held on the substrate holder 110. The alignment processing unit 26 moves the detection point P2 on the dividing target lines 13 in the same way as the inspection processing unit 28. The movement of the detection point P2 by the alignment processing unit 26 is made identically to the movement of the detection point P2 by the inspection processing unit 28, and, thus, description thereof will be omitted.

The present application is based on and claims priority to Japanese Patent Application No. 2018-069540 filed to the Japan Patent Office on Mar. 30, 2018, the entire contents of which are hereby incorporated herein by reference.

### EXPLANATION OF CODES

1: Plasma processing system
10: Substrate
11: First main surface
12: Second main surface
13: Dividing target line
16: Processing trace
20: Controller
27: Processing unit
28: Inspection processing unit
100: Laser processing unit (Laser processing device)
110: Substrate holder
130: Processing head unit
140: Substrate moving unit
142: Y-axis guide
150: Inspection unit
P1: Irradiation point
P2: Detection point

1. A laser processing device configured to respectively form processing traces along multiple dividing target lines of a substrate, the laser processing device comprising:
a substrate holder configured to hold the substrate;
a processing head unit configured to form an irradiation point of a laser beam for processing the substrate on a main surface of the substrate held on the substrate holder;
a substrate moving unit configured to move the substrate holder in a first axis direction and a second axis direction, which are orthogonal to each other and parallel to the main surface of the substrate, and configured to rotate the substrate holder around a third axis orthogonal to the main surface of the substrate; and
a controller configured to control the substrate moving unit,
wherein the controller includes a processing unit configured to repeat, while switching the multiple dividing target lines, moving the substrate holder in the first axis direction to move the irradiation point on the multiple dividing target lines and configured to rotate the substrate holder around the third axis during the moving of the substrate holder to change a direction of the substrate held on the substrate holder by 180°.

2. The laser processing device of claim 1, further comprising:
an inspection unit configured to detect the multiple dividing target lines of the substrate held on the substrate holder and the processing traces formed along the multiple dividing target lines,
wherein the substrate moving unit has a second axis guide which is extended in the second axis direction through the inspection unit and the processing head unit when viewed from the third axis direction, and
the substrate holder is moved along the second axis guide.

3. The laser processing device of claim 2,
wherein the controller includes an inspection processing unit configured to repeat, while switching the multiple dividing target lines, moving the substrate holder in the first axis direction to move a detection point for detecting the processing traces by the inspection unit on the dividing target lines and configured to rotate the substrate holder around the third axis during the moving of the substrate holder to change the direction of the substrate held on the substrate holder by 180°.

4. The laser processing device of claim 3,
wherein, in the substrate held on the substrate holder, a part of a moving area in which the substrate is moved by the processing unit and a part of a moving area in which the substrate is moved by the inspection processing unit are overlapped with each other.

5. The laser processing device of claim 3,
wherein the inspection unit includes multiple inspection units provided at an interval along the second axis direction, and the processing head unit is provided between two adjacent inspection units,
the substrate holder includes multiple substrate holders moved along the second axis guide independently of each other, and
a part of a moving area of the substrate held on a first one of the multiple substrate holders and moved by the processing unit and a part of a moving area of the substrate held on a second one of the multiple substrate holders and moved by the processing unit are overlapped with each other.

6. The laser processing device of claim 5,
wherein a distance between each of the detection points of the two adjacent inspection units and the irradiation point of the processing head unit provided therebetween in the second axis direction is equal to or greater than a diameter of the substrate.

7. A laser processing device configured to respectively form processing traces along multiple dividing target lines of a substrate, the laser processing device comprising:
a substrate holder configured to hold the substrate;
an inspection unit configured to detect the multiple dividing target lines of the substrate held on the substrate holder and the processing traces formed along the multiple dividing target lines;
a substrate moving unit configured to move the substrate holder in a first axis direction and a second axis direction, which are orthogonal to each other and parallel to a main surface of the substrate, and configured to rotate the substrate holder around a third axis orthogonal to the main surface of the substrate; and
a controller configured to control the substrate moving unit,
wherein the controller includes an inspection processing unit configured to repeat, while switching the multiple dividing target lines, moving the substrate holder in the first axis direction to move a detection point for detecting the processing traces by the inspection unit on the multiple dividing target lines and configured to rotate the substrate holder around the third axis during the moving of the substrate holder to change a direction of the substrate held on the substrate holder by 180°.

8. A laser processing method of forming an irradiation point of a laser beam for processing a substrate on a main surface on the substrate held on a substrate holder and respectively forming processing traces along multiple dividing target lines by moving the irradiation point in a first axis direction and a second axis direction orthogonal to each other,
wherein moving the substrate holder in the first axis direction is repeated while switching the multiple dividing target lines to move the irradiation point on the dividing target lines, and a direction of the substrate held on the substrate holder is rotated by 180° by rotating the substrate holder around a third axis orthogonal to the first axis direction and the second axis direction during the moving of the substrate holder.

9. A laser processing method of forming an irradiation point of a laser beam for processing a substrate on a main surface on the substrate held on a substrate holder and respectively forming processing traces along multiple dividing target lines by moving the irradiation point in a first axis direction and a second axis direction orthogonal to each other,
wherein moving the substrate holder in the first axis direction is repeated while switching the dividing target lines to move a detection point for detecting the processing traces by an inspection unit on the multiple dividing target lines, and a direction of the substrate held on the substrate holder is rotated by 180° by rotating the substrate holder around a third axis orthogonal to the first axis direction and the second axis direction during the moving of the substrate holder.
